(19) United States
(12) Patent Application Publication
(10) Pub. No.: US 2004/0242234 A1
(43) Pub. Date: Dec. 2, 2004

(54) Method and device for determining the position of a base station

(76) Inventor: Gunther Klenner, Rosenheim (DE)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/488,247

(22) PCT Filed: Sep. 21, 2002
(86) PCT No.: PCT/DE02/03577

(30) Foreign Application Priority Data
Sep. 21, 2001 (DE) 10146829.6

(51) Int. Cl. H04Q 7/20

(52) U.S. Cl. 455/446; 455/448

(57) ABSTRACT

The invention relates to a method for determining the position of a base station in a mobile radio network. The aim of the invention is to provide a reliable method for the rapid identification of the position of a base station with high precision, independent of prepublished plans. For this purpose, the position of the location, the number of a frame of a signal received by the base station and the time of receipt are determined at least in three locations and the position of the base station is established on the basis of these data. The invention further relates to a corresponding device for carrying out the inventive method.

The present invention relates to a method for determining the position of a base station. The invention also relates to a corresponding apparatus for carrying out the method.

Mobile radio networks which have a large number of base or fixed stations in order to supply respective radio cells are known from the prior art. The base stations are in this case provided for interchanging data with mobile devices, for example mobile telephones. It is now desirable to know the positions of the base stations. One important application for this is the surveying of the radio network. This is because, in order to allow the surveyed data to be evaluated correctly, a plan is required which includes the locations of the base stations. However, plans such as these are in some cases difficult to access, are not up to date, or are even secret. In addition, the survey is not carried out by the same group as that administering these plans. This all makes it harder to evaluate the measurement data and to analyze weaknesses and problems in the radio network.

The invention is therefore based on the object of avoiding the disadvantages of the prior art, and, in particular, of developing a method of the type mentioned initially such that the position of a base station can be determined easily and quickly, and with high accuracy, independently of published plans.

In the case of a method of the type mentioned initially, this object is achieved in that the position of the location, a number of a frame of a signal which is received from the base station as well as the time of reception are each determined at at least three locations, with the position of the base station being determined from this.

One advantage of the present invention is that it allows the position or location of a base station to be determined during a supply and quality survey (drive test) of cellular radio networks, for example radio networks. This simplifies subsequent analysis of the supply and quality measurement, since all the necessary data is actually available immediately after the survey. Furthermore, there is no need to obtain additional data from further sources.

A propagation time difference for the signal for two locations is preferably determined in each case from the difference between two times of reception of two frames and from the difference between the frame numbers, with a position of the base station being determined using hyperbolic position finding methods from at least two propagation time difference values determined in this way. More than two propagation time difference values may be used, in particular, to improve the accuracy of the measurement.

In this case, the difference between the frame numbers in the method is preferably taken into account in that the propagation time difference L is essentially calculated using the following formula

L=t₁−t₂−[(N₂−N₁)·T]

where t₁ is the time of reception of the first frame, t₂ is the time of reception of the second frame, N₁ is the frame number of the first frame, N₂ is the frame number of the second frame and T is essentially the time duration of a frame.

In order to define the time exactly, it is preferable that the reception of a predefined section of the frame is chosen as the time of reception of the frame. In this case, the predefined section may be the start of the frame or that section which contains the frame number.

One particularly simple and cost-effective implementation of the present invention comprises the provision of a receiver device for a satellite-assisted navigation system in order to determine the position and/or the time of reception of a frame. By way of example a GPS system can find positions very accurately and, in the process, likewise transmits a time standard to a GPS receiver based on the atomic clocks which are provided in the satellites.

A time pulse of a satellite-assisted navigation system is advantageously provided in order to initiate or start a measurement. This results in an exact time being preset, which corresponds in particular to a signal which initiates the measurement according to the invention of the position of the location, the frame number and the time of reception. The time pulse is also repeated periodically, so that it is ideally suitable for carrying out an entire series of measurements. If no GPS reception is available, the time signal is not transmitted either and the (impossible) measurement is not even started.

The time of reception of the frame is advantageously defined by a time, and the measurement of the time offset of the frame is defined with respect to this time. In this case, it is preferable for the time to be predetermined by a time standard, in particular a time pulse in a satellite-assisted navigation system. This allows the time pulse to be received independently of the frame position being received at this time, with the accuracy of the measurement being improved at the same time.

It is furthermore preferable for the method to be carried out while driving through a region in order to carry out a supply and/or quality measurement of the mobile radio network in that region. By driving through the region, different locations are driven to all the time, and appropriate measurements are carried out. In parallel with this, measurements are carried out in accordance with the present invention, so that the positions of base stations are known exactly after the journey, and the supply measurements can be evaluated in a meaningful way.

Further preferred embodiments of the invention are disclosed in the dependent patent claims.

The invention as well as further features, aims, advantages and application examples of it will be explained in more detail in the following text using a description and with reference to the attached drawings. In the drawings, the same reference symbols denote the same or corresponding elements. In this case, all of the described features and/or the illustrated features form the subject matter of the present invention in their own right or in any sensible combination, to be precise irrespective of their compilation in the patent claims or their back-references. In the drawings:

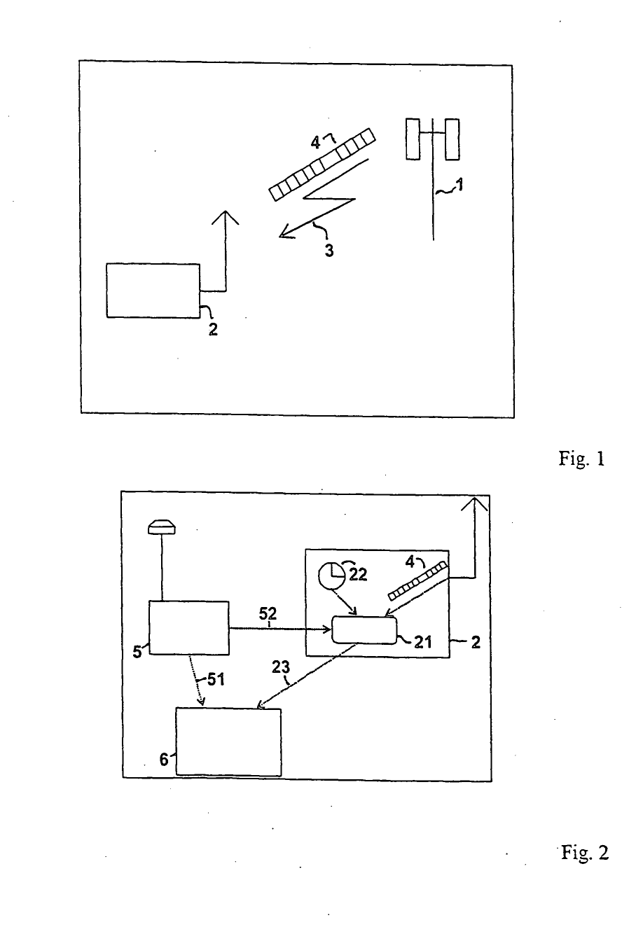

FIG. 1 shows a schematic illustration in order to explain the downlink communication in a mobile radio network;

FIG. 2 shows a schematic illustration in order to explain one preferred embodiment of the present invention, showing how measurements are carried out in each case; and

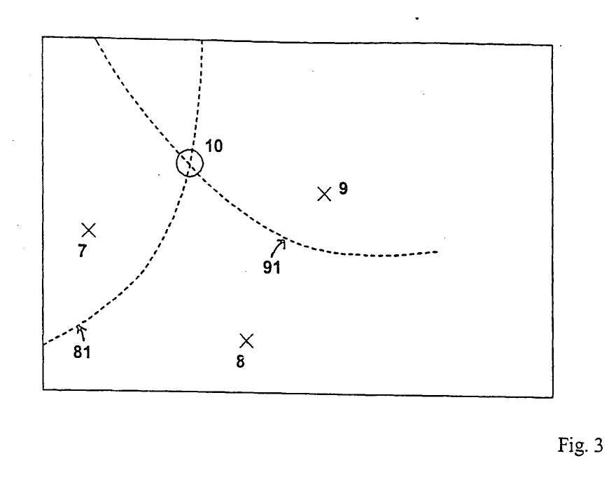

FIG. 3 shows a schematic illustration in order to explain one preferred embodiment of the present invention, showing how the position of a base station is determined from respective measurements as shown in FIG. 2.

FIG. 1 shows a schematic illustration of a base or fixed station 1, which is part of a mobile radio network, for example a GSM network (GSM=global system of mobile communications) . During operation, the base station communicates via the uplink channel and downlink channel with mobile stations, for example mobile telephones or cellular telephones. A receiver 2 is also shown, which has an antenna which receives signals that are transmitted from the base station 2 as indicated by the arrow 3 (downlink) . These signals are transmitted in blocks, so-called “frames” 4. In this case, the frames which are transmitted from the base station 1 each have a sequential frame number. The length of a frame is in this case constant to a very high degree of accuracy and is in the region of about 4.6 ms. The receiver 2 during operation of the mobile radio network is a mobile telephone. When carrying out supply and quality surveys (drive tests), which are known per se, on the radio network in the area of the base station 1, the receiver 2 is a test mobile telephone which is driven in a region around the base station 1 in a motor vehicle, in order to survey the region. In this case, one possible aim of a supply measurement such as this is to find out whether there are areas in which reception is adversely affected, for example as a result of natural obstructions.

The configuration of the apparatus according to the invention and the operation according to the present invention will be explained in more detail in the following text with reference to FIGS. 2 and 3. The apparatus and system according to the invention have a receiving device 2 which is preferably a test mobile telephone. The receiving device 2 has a decoder 21 for decoding the signals which are transmitted from the base station 1. The apparatus also has a position finding device, which is preferably a GPS receiver 5 (GPS=global positioning system). Other suitable position finding devices, in particular satellite-assisted devices based on a satellite system other than the GPS system may, of course, also be used in conjunction with the invention. Finally, the apparatus has a time determining device or measurement device, or clock, which is preferably likewise formed by the GPS receiver 5. In accordance with the GPS system, not only information related to the location but also a high-precision time signal is sent to a GPS receiver 5. However, in principle, any other suitable device may also be used as a high-precision time determining device, for example an atomic clock or radio clock. In particular, the time determining device which is used may be provided independently of and separately from the position finding device. However, in the preferred exemplary embodiment, it is in the form of a unit in the GPS receiver 5.

The apparatus is regularly used in or on a vehicle for a test drive. In addition to measuring the quality of the radio network, a measurement according to the present invention is carried out at a position which is initiated, for example, by an operation by an operator or automatically, for example at regular time intervals or physical intervals. A measurement is preferably initiated by a GPS time pulse, as will be explained in more detail in the following text. For this purpose, the GPS receiver 5 provides an absolute time with high precision, referred to in the following text as t_{1.}

Furthermore, the (next) frame 4 which is received at this time of the signal which is received from the base station is decoded by the decoder 21. The decoder 21 decodes not only the received information signals but, in particular, also the frame number r₁ of the frame 4. A frame number such as this is a characteristic of all digital radio networks, as was be described above in conjunction with FIG. 1. As has been identified by the present invention, this frame number likewise represents a relative time standard. A counter 22 is started when the GPS time pulse is received. The counter or timer (time trigger) 22 provides the time offset v₁ of the received frame with the frame number r₁ with respect to the absolute time t₁. The offset v₁ is in this case defined, for example, as the time difference between the absolute time and the start of the frame. Alternatively, the offset can be defined by that section of the frame 4 in which the frame number r₁ is transmitted. For this purpose, the position data 51 of the GPS receiver 5 at the time t₁+v₁, that is to say the location x₁ of the vehicle, is stored in a database 6. The frame number r₁ as well as the time offset v₁ of the absolute time t₁ with respect to the frame reception additionally with respect to the absolute time t₁, and associated with it, are also stored in the database 6. A time reference point is thus obtained in addition to a known physical reference point, and these are stored for analysis.

In a corresponding manner, when the vehicle is moved further, the frame number r₂ of the (next) frame 4 is decoded by the decoder 21, and the offset v₂ is determined, at the absolute time t₂ as provided by the GPS. Furthermore, the position data 51 for the GPS receiver 5, that is to say the location x₂ of the vehicle, at the time t₂+v₂ is stored in the database 6. The frame number r₂ as well as the time offset v₂ of the absolute time t₂ with respect to the frame reception and additionally with respect to the absolute time t₂, and associated with it, are additionally stored in the memory 6. Since the frames 4 are transmitted at fixed time intervals, to be precise with high accuracy approximately every 4.6 ms, which corresponds to the frame length, and the frame number difference r₂−r₁, is known it is possible to calculate the propagation time difference. If the two frames with the numbers r₁ and r₂ were to be transmitted from the base station at the same time, the propagation time difference would simply be the difference between the absolute times of reception of the frames r₁ and r₂ at the two locations x₁ and x₂, that is to say (t₁+v₁)−(t₂+v₂). In order now to obtain the real propagation time difference for the frames r₁ and r₂ at the two locations x₁ and x₂, it is necessary to subtract the difference between the transmission times of the two frames from (t₁+v₁)−(t₂+v₂). The propagation time difference is thus (t₁+v₁)−(t₂+v₂)−[(r₂−r₁)·4.6 ms].

The position of the base station is now determined by means of a hyperbolic position finding method from the propagation time difference determined at the locations x₁ and x₂. In this context, reference is made to FIG. 3. This propagation time difference of the radio signal between two locations 7, 8 (corresponding to x₁ and x₂, respectively as already mentioned) forms a part of the hyperbolic position finding process. All the possible transmission locations, that is to say positions of the base station transmitting the frames on which the measurement is based and from which this propagation time difference would occur are located on a hyperbolic line 81 on a map. If a further propagation time difference is now added, for example either from a third location 9 (X₃) or from two further locations X₃ and X₄, a second hyperbola 91 is defined. The base station 1 is therefore located at the intersection 10 of the two hyperbolae 81, 91. The evaluation is preferably carried out by an appropriate microprocessor or PC.

Mathematical methods can use the results of two or more surveys in order to eliminate measurement errors, and in the process to determine the target position with even more accuracy. This is of particular interest in the application mentioned above, since this can be carried out continuously using the GPS time pulses which are based on seconds, thus providing a very large amount of measurement data.

The invention has been explained in more detail above with reference to preferred embodiments of it. However, it is obvious to a person skilled in the art that various changes and modifications can be made without departing from the idea on which the invention is based.

### List of reference symbols

1 Base or fixed station

2 Receiving device or test mobile

21 Decoder

22 Timer

23 Frame number +offset

3 Radio path

4 Data block (frame)

5 (GPS) receiver device

51 Position data

52 Time pulse

6 Data gatherer

7 First measurement point

8 Second measurement point

81 Position-finding line of the first and the second measurement point

9 Third measurement point

91 Position-finding line second and third measurement point

10 Target position

I claim:

1. A method for determining the position of a base station in a mobile radio network, wherein the position of the location, a number of a frame of a signal which is received from the base station as well as the time of reception of the frame are each determined at at least three locations, with the position of the base station being determined from this.

2. The method as claimed in claim 1, wherein a propagation time difference for the signal for two locations is determined in each case from the difference between two times of reception of two frames and from the difference between the frame numbers, with a position of the base station being determined using the hyperbolic position finding method from at least two propagation time difference values determined in this way.

3. The method as claimed in claim 2, wherein the propagation time difference L is essentially calculated using the following formula
L=t₁−t₂−[(N₂−N₁)·T]
where t₁ is the time of reception of the first frame, t₂ is the time of reception of the second frame, N₁ is the frame number of the first frame, N₂ is the frame number of the second frame and T is essentially the time duration of a frame.

4. The method as claimed in claim 1, wherein the reception of a predefined section of the frame is chosen as the time of reception of the frame.

5. The method as claimed in claim 4, wherein the predefined section is the start of the frame or that section which contains the frame number.

6. The method as claimed in claim 1, wherein a receiver device for a satellite-assisted navigation system is provided in order to determine the position and/or the time of reception of a frame.

7. The method as claimed in claim 1, wherein a measurement is initiated by a time pulse from a satellite-assisted navigation system.

8. The method as claimed in claim 1, wherein the time of reception of the frame is defined by a time and by the measurement of the time offset of the frame with respect to this time.

9. The method as claimed in claim 8, wherein the time is predetermined by a time standard, in particular a time pulse from a satellite-assisted navigation system.

10. The method as claimed in claim 1, wherein the method is carried out while driving through a region in order to carry out a supply measurement and/or quality measurement of the mobile radio network in that region.

11. An apparatus for determining the position of a base station in a mobile radio network, in particular for carrying out the method as claimed in claim 1, wherein the apparatus comprises a position determining device, a decoding device and a time determining device, with the position determining device determining the position of the location, the decoding device determining the number of a frame of a signal which is received from the base station, and the time determining device determining the time of reception of the frame at each of at least three locations, and with the position of the base station being determined from this.

12. The apparatus as claimed in claim 11, wherein a propagation time difference for the signal is determined for each of two locations from the difference between two times of reception of two frames and from the difference between the frame numbers, with a position of the base station being determined from at least two propagation time difference values determined in this way, using the hyperbolic position finding method.

13. The apparatus as claimed in claim 12, wherein the propagation time difference L is essentially calculated using the following formula
L=t₁−t₂−[(N₂−N₁)·T]
where t₁ is the time of reception of the first frame, t₂ is the time of reception of the second frame, N₁ is the frame number of the first frame, N₂ is the frame number of the second frame and T is essentially the time duration of a frame.

14. The apparatus as claimed in claim 11, wherein the reception of a predefined section of the frame is chosen as the time of reception of the frame.

15. The apparatus as claimed in claim 14, wherein the predefined section is the start of the frame or that section which contains the frame number.

16. The apparatus as claimed in claim 11, wherein a receiver device for a satellite-assisted navigation system is provided as the position determining device and/or as the time determining device for reception of a frame.

17. The apparatus as claimed in claim 11, wherein a measurement is initiated by a time pulse from a satellite-assisted navigation system.

18. The apparatus as claimed in claim 11, wherein the apparatus comprises a counter device, with the time of reception of the frame being determined by a time and by the measurement, which is carried out by the counter device, of the time offset of the frame with respect to this time.

19. The apparatus as claimed in claim 18, wherein the time is predetermined by a time standard, in particular a time pulse from a satellite-assisted navigation system.

20. The apparatus as claimed in claim 11, wherein the apparatus is arranged in or on a vehicle in order to carry out the method while driving through a region in order to carry out a supply measurement and/or quality measurement of the mobile radio network in that region.

21. The apparatus as claimed in claim 11, wherein the decoding device is embodied in a measurement mobile telephone.
